(19) United States
(12) Patent Application Publication
(10) Pub. No.: US 2025/0293321 A1
(43) Pub. Date: Sep. 18, 2025

(54) LI-POLYMER BATTERY

(71) Applicant: SHENZHEN ORIENTAL WILLING NEW ENERGY CO., LTD, Shenzhen (CN)

(72) Inventor: Kunli Wang, Shenzhen (CN)

(21) Appl. No.: 18/654,353

(22) Filed: May 3, 2024

(30) Foreign Application Priority Data
Mar. 15, 2024 (CN) 202420520886.1

(51) Int. Cl. H01M 10/42; H01M 10/052; H01M 50/202; H01M 50/284; H01M 50/55

(52) U.S. Cl. CPC H01M 10/425; H01M 10/052; H01M 50/202; H01M 50/284; H01M 50/55

(57) ABSTRACT

Disclosed is a li-polymer battery, which includes a housing, a li-polymer core arranged within the housing, a positive terminal disposed at a top end of the li-polymer core, and a negative terminal disposed at the top end of the li-polymer core and on a side of the positive terminal, wherein the li-polymer battery further includes a PCB assembly encapsulated within the housing and arranged above the li-polymer core, the PCB assembly includes a PCB board holder and a PCB board disposed on the PCB board holder, the PCB board has a positive connection portion and a negative connection portion which are capable of passing through the PCB board holder for electrically contacting the positive terminal and the positive terminal of the li-polymer core, and wherein the PCB board is provided with a charging/discharging interface, and the housing has an opening for accessing the charging/discharging interface.

### TECHNICAL FIELD

The present disclosure relates to the field of battery, in particular, to a li-polymer battery.

### BACKGROUND

Li-polymer battery packs can be widely used in various electronic devices, such as cellular telephones, laptop computers, video recorders with built-in cameras.

With the development of technology, a battery with better performance is required in some scenarios. Currently, most li-polymer batteries are charged in a traditional charging manner, which is not applicable in many occasions. A new li-polymer battery with a nut and a stud which are weld inside the battery has appeared, wherein a positive pole and a negative pole are electrically connected by means of the nut and the stud, resulting in a poor installation efficiency of the new li-polymer battery and high labor cost. This new li-polymer battery is seldom chosen by a user. Therefore, there is an urgent need for cost-effective li-polymer batteries.

### SUMMARY

It is an object of embodiments of the present disclosure to provide a li-polymer battery, aiming to solve the technical problems of low installation efficiency and high cost of li-polymer batteries in the prior art.

A li-polymer battery is provided, which comprises a housing, a li-polymer core arranged within the housing, a positive terminal disposed at a top end of the li-polymer core, and a negative terminal disposed at the top end of the li-polymer core and on a side of the positive terminal, wherein the li-polymer battery further comprises a PCB assembly encapsulated within the housing and arranged above the li-polymer core, the PCB assembly includes a PCB board holder and a PCB board disposed on the PCB board holder, the PCB board has a positive connection portion and a negative connection portion which are capable of passing through the PCB board holder for electrically contacting the positive terminal and the positive terminal of the li-polymer core, and wherein the PCB board is provided with a charging/discharging interface, and the housing has an opening for accessing the charging/discharging interface.

In some embodiments, the PCB board holder includes a base plate and two bosses spaced apart on the base plate, each of the bosses is provided with a first through-hole extending through the base plate, and the positive connection portion and the negative connection portion respectively pass through the first through-holes for electrically connecting the positive terminal and the negative terminal, and wherein a first notch is formed between the bosses and provided proximate to a forward end of the base plate for facilitating mounting of the charging/discharging interface.

In some embodiments, the PCB board holder further includes four side panels disposed at front, rear, left, and right sides of the base plate, wherein the rear side panel is provided with a second through-holes in communication with the first through-hole, and wherein the positive terminal and the negative terminal are flexible parts having a L-shape, the positive terminal and the negative terminal extend into the first through-holes and electrically contact the positive connection portion and the negative connection portion, and the front side panel has a second notch corresponding to the first notch.

In some embodiments, protrusions are provided on outer surfaces of the left and right side panels of the PCB board holder, the housing is a rectangular body having an accommodation cavity, and the protrusions are respectively against left and right inner walls of the accommodation cavity.

In some embodiments, inwardly bendable first connecting members are provided at top of left and right side walls of the accommodation cavity, and welding portions, on left and right sides, are provided on an upper surface of the PCB board, wherein, after the PCB board is placed in the accommodation cavity, two first connecting members are bent inwardly and welded with the welding portions, and the first connecting members are located on two projections.

In some embodiments, the positive connection portion and the negative connection portion are configured as springs or steel pillars having elasticity.

In some embodiments, a positive leading part and a negative leading part are provided on the top of the PCB board, an insulating layer is provided on the PCB board, and the insulating layer includes third through-holes for the positive leading part and the negative leading part and third notches for the first connecting members.

In some embodiments, the insulating layer is superposed by a pad with fourth through-holes for the positive leading part and the negative leading part, and wherein the pad, at its top, is connected to a guide frame, and the guide frame is provided with two toothed disks corresponding to the fourth through-holes, a gear meshed with the toothed disks, and a rack meshed with the gear, wherein the rack is slidable on the guide frame, the toothed disks are rotatably connected to the pad, and each of the toothed disks has a fifth through-hole corresponding to the fourth through-holes.

In some embodiments, the charging/discharging interface is a Type-C interface.

In some embodiments, a leading frame is provided on an outer surface of the housing and located at the opening, the leading frame has a pushing board for covering the opening, wherein the pushing board is slidably connected to the leading frame such that a height of the pushing board is adjustable, and wherein a pair of strips are connected to the leading frame on two sides, and edges of the pushing board are sandwiched between surfaces of the strips and the outer surface of the housing, and the pushing board is slidable with respect to the surfaces of the strips and the outer surface of the housing.

The technical solution of the present disclosure has the following beneficial effects:

the PCB board holder is provided within the battery, and the PCB board is placed on the PCB board holder such that the positive connection portion on a bottom of the PCB board passes through the PCB board holder and contacts the positive terminal to enable electric connection, and the negative connection portion on the bottom of the PCB board passes through the PCB board holder and contacts the negative terminal to enable electric connection. This design allows absence of a stud and a nut to be connected to the stud, which makes the production process simpler and more efficient. This li-polymer battery may be charged or powered to an electronic device through the charging/discharging interface, such convenient li-polymer battery enhances the market competitiveness. On the other hand, a guide frame is provided to facilitate installing and protecting a pad, and a leading frame is provided to protect the charging/discharging interface of the li-polymer battery.

### BRIEF DESCRIPTION OF THE DRAWINGS

In order to more clearly illustrate the technical solutions in the embodiments of the present disclosure, the accompanying drawings to be used in the description of the embodiments or prior art will be briefly introduced below, and it will be obvious that the accompanying drawings in the following description are only some of the embodiments of the present disclosure.

FIG. 1 shows an exploded schematic diagram of a li-polymer battery according to an embodiment.

FIG. 2 shows a schematic diagram of a core and a PCB board holder of a li-polymer battery according to an embodiment.

FIG. 3 shows a schematic diagram of a PCB board of a li-polymer battery according to an embodiment.

FIG. 4 shows a schematic diagram of a push board of a li-polymer battery according to an embodiment.

FIG. 5 shows a schematic diagram of structures within a guide frame of a li-polymer battery according to an embodiment.

FIG. 6 shows an exploded view of the push board and a leading frame of a li-polymer battery according to an embodiment.

### REFERENCE LIST

1—housing; 11—opening; 12—first connecting member; 13—accommodation cavity; 2—li-polymer core; 21—positive terminal 21; 22—negative terminal; 3—PCB assembly; 31—PCB board holder; 311—base plate; 312—boss; 313—first through-hole; 314—first notch; 315—front side panel; 316—rear side panel; 317—second through-hole; 318—second notch; 319—protrusion; 32—PCB board; 321—positive connection portion; 322—negative connection portion; 323—charging/discharging interface; 324—projection; 325—positive leading part; 326—negative leading part; 4—insulating layer; 41—third through-hole; 42—third notch; 5—pad; 51—fourth through-hole; 6—guide frame; 61—magnet; 62—slider 63—guide groove; 64—rack; 641—bump; 65—gear; 66—toothed disk; 661—fifth through-hole; 7—encasing plate; 71—sixth through-hole; 8—leading frame; 81—strip; 82—positioning block; 9—pushing board; 91—protuberance; 92—metal strip.

### DETAILED DESCRIPTION

In order to make the technical problems, technical solutions and beneficial effects to be solved by the present disclosure clearer, the present disclosure is hereinafter described in further detail in combination with the accompanying drawings and embodiments. It should be understood that the specific embodiments described herein are only for the purpose of explaining the present disclosure and are not intended to limit the present disclosure.

It should be appreciated that when an element is recited to be “fixed to” or “mounted to” another element, it means that this element can be directly or indirectly fixed to another element. It should be appreciated that when an element is recited to be “connected to” another element, it means that this element can be directly or indirectly connected to another element.

It is to be understood that orientations or positional relationships described by terms such as “length”, “width”, “upper”, “low”, “forward”, “back”, “left”, “right”, “vertical”, “horizontal”, “top”, “bottom”, “inside”, “outside” indicate orientations or positional relationships shown in the accompanying drawings, which are intended only to facilitate the description of this disclosure and are not intended to indicate or imply particular orientations of devices or elements in the embodiments or operations depending on particular orientations of them, and therefore are not intended to limit the present disclosure.

Furthermore, terms “first” and “second” are used only for descriptive purposes, and are not to be construed as indicating or implying preferability or implicitly specifying number of technical features indicated. A feature defined with “first” or “second” may explicitly or implicitly means one or more features. In this disclosure, term “a plurality of” means two and more, and term “several” means one or more, unless otherwise expressly and specifically limited.

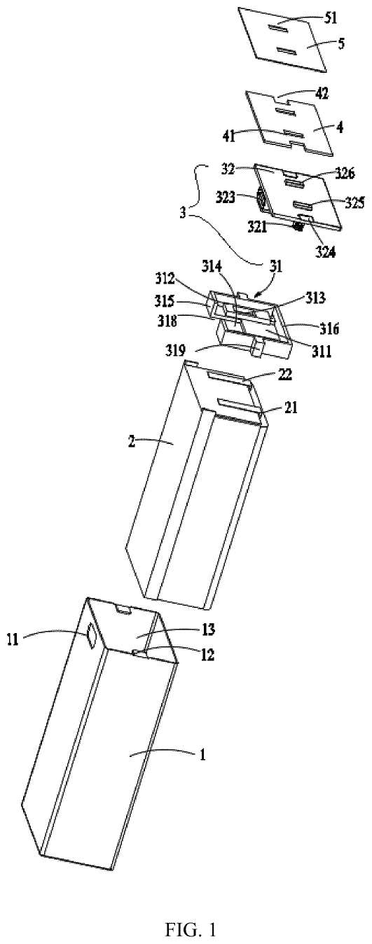

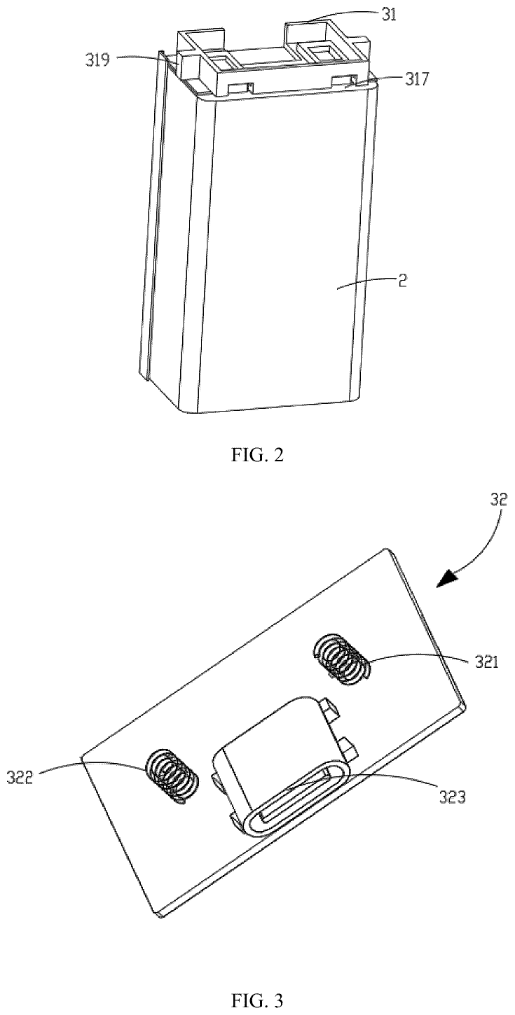

Referring to FIGS. 1-3, a li-polymer battery according to an embodiment is provided. The li-polymer battery includes a housing 1, a li-polymer core 2 arranged within the housing 1, a positive terminal 21 disposed at a top end of the li-polymer core 2, and a negative terminal 22 disposed at the top end of the li-polymer core 2 and on a side of the positive terminal 21. The li-polymer battery further includes a PCB assembly 3 encapsulated within the housing 1 and arranged above the li-polymer core 2. The PCB assembly 3 includes a PCB board holder 31 and a PCB board 32 provided on the PCB board holder 31, the PCB board 32 has a positive connection portion 321 and a negative connection portion 322 which are capable of passing through the PCB board holder 31 for electrically contacting the positive terminal 21 and the positive terminal 21. The PCB board 32 may be provided with a charging/discharging interface 323, and the housing 1 correspondingly has an opening 11 for accessing the charging/discharging interface 323.

In some embodiments, the PCB board holder 31 is provided within the battery, and the PCB board 32 is placed on the PCB board holder 31 such that the positive connection portion 321 on a bottom of the PCB board 32 passes through the PCB board holder 31 and contacts the positive terminal 21 to enable electric connection, and the negative connection portion 322 on the bottom of the PCB board 32 passes through the PCB board holder 31 and contacts the negative terminal 22 to enable electric connection. This design allows absence of a stud and a nut to be connected to the stud, which makes the production process simpler and more efficient. This li-polymer battery may be charged or powered to an electronic device through the charging/discharging interface 323, such convenient li-polymer battery enhances the market competitiveness.

In some embodiments, the PCB board holder 31 includes a base plate 311 and two bosses 312 spaced apart on the base plate 311 (only one boss 312 is shown in FIG. 1, due to the symmetrical setup). Each of the two bosses 312 is provided with a first through-hole 313 extending through the base plate 311, and the positive connection portion 321 and the negative connection portion 322 respectively pass through first through-holes 313 for electrically connecting the positive terminal 21 and the negative terminal 22. A first notch 314 is formed between two bosses 312 and provided proximate to a forward end of the base plate 311 for facilitating mounting of the charging/discharging interface 323.

In some embodiments, the PCB board holder 31 also includes four side panels disposed at front, rear, left, and right sides of the base plate 311, i.e. the four side panels comprise a front side panel 315, a rear side panel 316, a left side panel and a right side panel. The rear side panel 316 is provided with a second through-holes 317 in communication with the first through-holes 313. The positive terminal 21 and the negative terminal 22 are flexible parts having a L-shape, wherein a portion A of the flexible part (the positive terminal 21 or the negative terminal 22) is arranged on a top of the li-polymer core 2, and another portion B of the flexible part extends into the li-polymer core 2. The positive terminal 21 and the negative terminal 22 extend into the first through-holes 313 and electrically contact the positive connection portion 321 and the negative connection portion 322. The front side panel 315 has a second notch 318 corresponding to the first notch 314. In some embodiments, a part of the portion A of the positive terminal 21 or the negative terminal 22 is accommodated in the second through-hole 317, if the portion A of the flexible part, on the top of the li-polymer core 2, has a length greater than a length of the first through-hole 313.

In some embodiments, the positive connection portion 321 and the negative connection portion 322 are configured as springs or are pillars having elasticity. The positive terminal 21 and the negative terminal 22 are flexible parts, so that the electrical connection of the positive terminal 21 and the positive connection portion 321 and the electrical connection of the negative terminal 22 and the negative connection portion 322 can be realized by contacting and pressing elastic part, which is reliable.

In some embodiments, protrusions 319 are provided on outer surfaces of the left and right side panels of the PCB board holder 31. The housing 1 is a rectangular body having an accommodation cavity 13. The protrusions 319 are respectively against left and right inner walls of the accommodation cavity 13, and the PCB board holder 31 is secured by the protrusions 319 against the left and right inner walls of the accommodation cavity 13.

In some embodiments, inwardly bendable first connecting members 12 are provided at top of left and right side walls of the accommodation cavity 13, and welding portions 324, on left and right sides, are provided on an upper surface of the PCB board 32. After the PCB board 32 is placed in the accommodation cavity 13, two first connecting members 12 are bent inwardly and welded with the welding portions 324, and the first connecting members 12 are located on two projections when cooperating with the welding portions. In some embodiments, the welding portion is configured as a nickel sheet. In this way, the PCB board is fixed within the accommodation cavity 13 by welding the first connecting members 12 with the welding portion 324, and the two projections 324 support welding connection between the first connecting members 12 and the welding portion 324, which makes the connection between the PCB board 32 and the PCB board holder 31 more reliable.

In some embodiments, a positive leading part 325 and a negative leading part 326 are provided on the top of the PCB board 32. An insulating layer or paper 4 is provided to cover the PCB board 32, and the insulating layer 4 includes third through-holes 41 for the positive leading part 325 and the negative leading part 326 and third notches 42 for the first connecting members 12. The first connecting member 12 may pass through the third notch 42 to weld with the welding portion 324 on the upper surface of the PCB board 32.

In some embodiments, the insulating layer 4 is superposed by a pad 5 with fourth through-holes 51 for the positive leading part 325 and the negative leading part 326. The pad 5 can effectively prevent dust and other debris from falling into interior of the battery and cover the welding points.

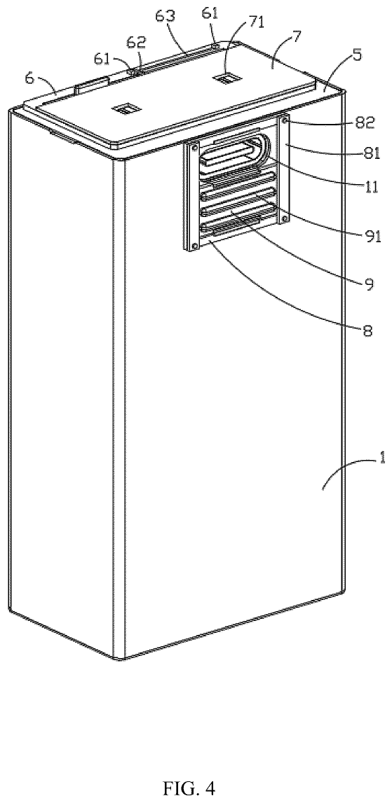

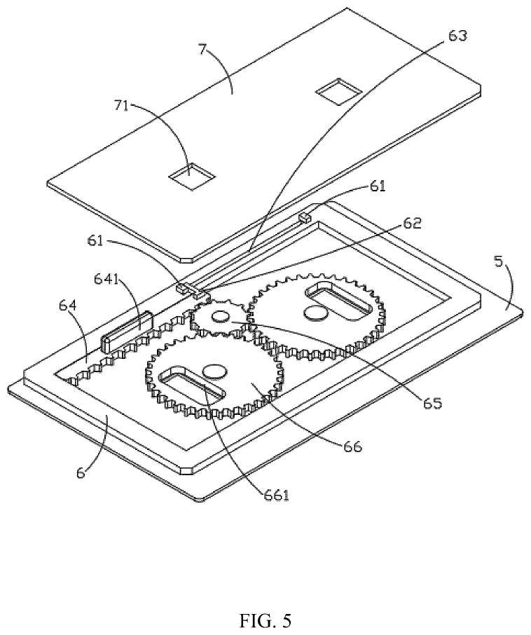

In some embodiments, as shown in FIGS. 4 and 5, the pad 5, at its top, is connected to a guide frame 6, and the guide frame 6 is provided with two toothed disks 66 corresponding to the fourth through-holes 51, a gear 65 meshed with the toothed disks 66, and a rack 64 meshed with the gear 65. The rack 64 is slidable on the guide frame 6. The toothed disks 66 and the gear 65 are rotatably connected to the pad 5, and each of the toothed disks 66 has a fifth through-hole 661 corresponding to the fourth through-holes 51.

Preferably, the guide frame 6 is provided with a guide groove 63, and a slider 62 is fixedly connected to an outer surface of the rack 64, so that the slider 62 extends into the guide groove 63 and slidably connected to the guide groove 63.

In some embodiments, the slider 62 is made of metal, and a pair of magnets 61 disposed at two ends of the guide groove 63 are fixedly connected to outer surface of the guide frame 6, and the magnets 61 are used for magnetic attraction with the slider 62.

Preferably, the rack 64, at its outer surface, is fixedly connected with a bump 641 for increasing the contact friction.

Preferably, an encasing plate 7 is fixedly connected to outer side surface of the guide frame 6 and arranged directly above the gear 65 and the two toothed disks 66, and the encasing plate 7 is provided with sixth through-holes 71 located directly above the fourth through-holes 51.

In some embodiments, the charging/discharging interface 323 is a Type-C interface.

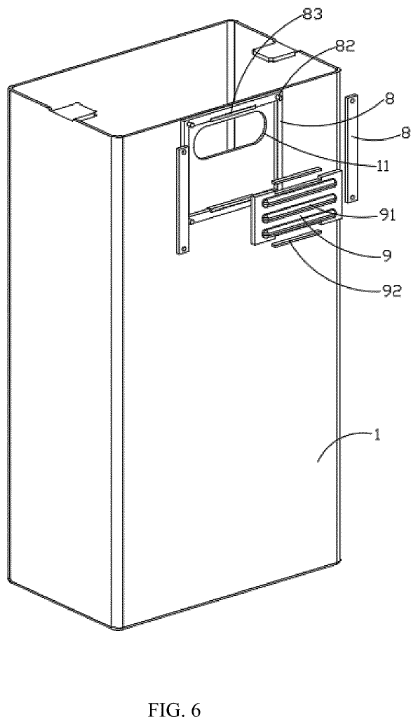

In some embodiments, as shown in FIGS. 4 and 6, a leading frame 8 is provided on an outer surface of the housing 1 and located at the opening 11, the leading frame 8 has a pushing board 9 for covering the opening 11. The pushing board 9 is slidably connected to the leading frame 8 such that a height of the pushing board 9 is adjustable. A pair of strips 81 are connected to the leading frame 8 on two sides, and two side edges of the pushing board 9 are sandwiched between surfaces of the strips 81 and the outer surface of the housing 1. The pushing board 9 is slidable with respect to the surface of the strips 81 and the outer surface of the housing 1.

Preferably, the pushing board 9 connects to metal strips 92 at its top and bottom, and the leading frame 8 is provided with a pair of magnetic strips 83 for magnetically attracting to the metal strips 92. The magnetic strips 83 are respectively arranged at top and bottom of the leading frame 8, corresponding to two metal strips 92.

Preferably, one or more protuberances 91 provided on the outer surface of the pushing board 9 and located between the strips 81 are configured for increasing contact friction.

Preferably, the leading frame 8 is provided with a positioning mechanism for the strips 81, wherein the positioning mechanism includes a pair of positioning blocks 82 fixedly connected to the outer surface of the leading frame 8. The positioning blocks 82 are arranged at upper and lower ends of the leading frame 8 and extend through the strips 81.

In summary, the above-described structure makes the internal structure of the li-polymer battery simple, reliable, and convenient for charging and power supply.

The foregoing description are only embodiments of the present disclosure, but the scope of protection of the present disclosure is not limited thereto, and any technician skilled in the art can easily think of changes or substitutions within the scope of the technology disclosed in the present disclosure, all of which should be covered by the scope of protection of the present disclosure.

1. A li-polymer battery, comprising a housing, a li-polymer core arranged within the housing,
a positive terminal disposed at a top end of the li-polymer core,
and a negative terminal disposed at the top end of the li-polymer core and on a side of the positive terminal,
wherein the li-polymer battery further comprises a PCB assembly encapsulated within the housing and arranged above the li-polymer core, the PCB assembly includes a PCB board holder and a PCB board disposed on the PCB board holder, the PCB board has a positive connection portion and a negative connection portion which are capable of passing through the PCB board holder for electrically contacting the positive terminal and the positive terminal of the li-polymer core respectively, and wherein the PCB board is provided with a charging/discharging interface, and the housing has an opening for accessing the charging/discharging interface.

2. The li-polymer battery of claim 1, wherein the PCB board holder includes a base plate and two bosses spaced apart on the base plate, each of the bosses is provided with a first through-hole extending through the base plate, and the positive connection portion and the negative connection portion respectively pass through the first through-holes for electrically connecting the positive terminal and the negative terminal, and wherein a first notch is formed between the bosses and provided proximate to a forward end of the base plate for facilitating mounting of the charging/discharging interface.

3. The li-polymer battery of claim 2, wherein the PCB board holder further includes four side panels disposed at front, rear, left, and right sides of the base plate, wherein the rear side panel is provided with a second through-holes in communication with to the first through-hole, and wherein the positive terminal and the negative terminal are flexible parts having a L-shape, the positive terminal and the negative terminal extend into the first through-holes and electrically contact the positive connection portion and the negative connection portion, and the front side panel has a second notch corresponding to the first notch.

4. The li-polymer battery of claim 3, wherein protrusions are provided on outer surfaces of the left and right side panels of the PCB board holder, the housing is a rectangular body having an accommodation cavity, and the protrusions are respectively against left and right inner walls of the accommodation cavity.

5. The li-polymer battery of claim 4, wherein inwardly bendable first connecting members are provided at top of left and right side walls of the accommodation cavity, and welding portions, on left and right sides, are provided on an upper surface of the PCB board, wherein, after the PCB board is placed in the accommodation cavity, two first connecting members are bent inwardly and welded with the welding portions, and the first connecting members are located on two projections.

6. The li-polymer battery of claim 1, wherein the positive connection portion and the negative connection portion are configured as springs or steel pillars having elasticity.

7. The li-polymer battery of claim 5, wherein a positive leading part and a negative leading part are provided on the top of the PCB board, an insulating layer is provided on the PCB board, and the insulating layer includes third through-holes for the positive leading part and the negative leading part and third notches for the first connecting members.

8. The li-polymer battery of claim 7, wherein the insulating layer is superposed by a pad with fourth through-holes for the positive leading part and the negative leading part, and
wherein the pad, at its top, is connected to a guide frame, and the guide frame is provided with two toothed disks corresponding to the fourth through-holes, a gear meshed with the toothed disks, and a rack meshed with the gear, wherein the rack is slidable on the guide frame, the toothed disks are rotatably connected to the pad, and each of the toothed disks has a fifth through-hole corresponding to the fourth through-holes.

9. The li-polymer battery of claim 1, wherein the charging/discharging interface is a Type-C interface.

10. The li-polymer battery of claim 1, wherein a leading frame is provided on an outer surface of the housing and located at the opening, the leading frame has a pushing board for covering the opening, wherein the pushing board is slidably connected to the leading frame such that a height of the pushing board is adjustable, and wherein a pair of strips are connected to the leading frame on two sides, and edges of the pushing board are sandwiched between surfaces of the strips and the outer surface of the housing, and the pushing board is slidable with respect to the surfaces of the strips and the outer surface of the housing.
